(19) United States
(12) Patent Application Publication
(10) Pub. No.: US 2011/0317447 A1
(43) Pub. Date: Dec. 29, 2011

(54) BACKLIGHT MODULE

(75) Inventor: JIN-MIN HE, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/902,230

(22) Filed: Oct. 12, 2010

(30) Foreign Application Priority Data
Jun. 24, 2010 (CN) 201020235570.6

(51) Int. Cl. F21V 7/22

(52) U.S. Cl. 362/607; 362/606

(57) ABSTRACT

A backlight module includes a housing, a light source, a light guide plate, a diffuser plate and a prism plate, and the light source, the light guide plate, the diffuser plate and the prism plate are received within the housing. The housing includes reflective coating located on an inner surface of the housing. The light source provides light beams; the light guide plate converts the light beams into corresponding surface light source. The diffuser plate is mounted on the light guide plate and unifies the light beams from the light guide plate. The prism plate is mounted on the diffuser plate and increases the illumination of the light beams. Thus, parts of the light beams are reflected by the reflective coating back to the light guide plate, and the reflected light beams pass through the diffuser plate and the prism plate.

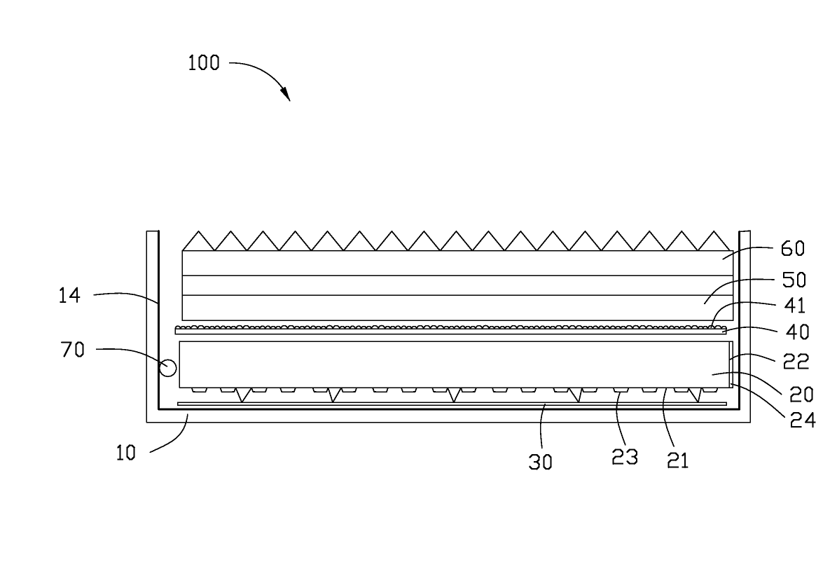

### BACKGROUND

1. Technical Field

The disclosure generally relates to backlight modules, and more particularly relates, to a backlight module used in an LCD (liquid crystal display).

2. Description of the Related Art

LCD devices are thin and light weight, and are driven by a low voltage. Thus, the LCD devices are extensively employed in electronic devices, such as mobile phones.

In an LCD device, usually a backlight module having a light source, a light guide device and a light reflecting device is used to provide the needed illumination. The light source emits light beams to the light guide device and the light reflective device, which then transmits the light beams to illuminate liquid crystal molecules in a liquid crystal panel. It is important that the light guide device uniformly transmit light beams to liquid crystal panel. However, conventional backlight modules are not always able to provide uniform illumination due to the light leakage of the light guide device where the leaked light beams are not reflected to be reused, which wastes light source and reduces illumination of the liquid crystal panel.

Therefore, there is room for improvement within the art.

### BRIEF DESCRIPTION OF THE DRAWINGS

Many aspects of an exemplary backlight module can be better understood with reference to the following drawings. The components in the drawings are not necessarily drawn to scale, the emphasis instead being placed upon clearly illustrating the principles of the exemplary backlight module. Moreover, in the drawings, like reference numerals designate corresponding parts throughout the several views. Wherever possible, the same reference numbers are used throughout the drawings to refer to the same or like elements of an embodiment.

The drawing is a schematic view of a backlight module, according to an exemplary embodiment.

### DETAILED DESCRIPTION

The drawing shows an exemplary embodiment of a backlight module 100 used in a liquid crystal display (LCD) of an electronic device, which may be a mobile phone, or a personal digital assistant (PDA). The backlight module 100 includes a housing 10, a light guide plate 20, a reflective plate 30, a diffuser plate 40, a first prism plate 50, a second prism plate 60, and a light source 70. The light guide plate 20, the reflective plate 30, the diffuser plate 40, the first prism plate 50, the second prism plate 60 and the light source 70 are received within the housing 10. In this exemplary embodiment, the housing 10 is an LCD housing.

The light source 70 may be a point light source, such as light emitting diode (LED), or be a line light source, such as Cold Cathode Fluorescent Lamp (CCFL). The light source 70 emits and provides light beams for the light guide plate 20. Thus, most of the light beams emitted from the light source 70 enter the diffuser plate 40 through the light guide plate 20, and then the emitted light beams pass through the diffuser plate 40 to enter the first prism plate 50 and the second prism plate 60.

The housing 10 may be made from metal or plastic with high reflectance, or be made from metal or plastic with high reflective coatings. In this exemplary embodiment, the housing 10 has an inner surface, and a reflective coating 14 is coated on the inner surface. The reflective coating 14 has high reflectance and reflects the leaked light beams from the light guide plate 20 back to the light guide plate 20. The reflective coating 14 is made from aluminum, silver or other reflective material.

The light guide plate 20 is made from a transparent material, such as glass or plastic. The plastic material can be any of acrylic, polyvinylchloride resin (PVC), polycarbonate (PC), polystyrene (PS) or polypropylene (PP). The light guide plate 20 includes an emitting surface 21 and a peripheral surface 22 substantially perpendicular to the emitting surface 21. The emitting surface 21 includes a number of optical dots 23. The optical dots 23 are formed by cutting or etching, are arranged in a uniform matrix formation, and are substantially frustum-shaped.

The optical dots 23 on the emitting surface 21 scatter, reflect, and uniformly incident light beams, as to almost completely eliminate internal reflection of the light beams and cause the light beams to be emitted more uniformly and convert the point light source or the line light source into uniform surface light source. In this exemplary embodiment, a reflective layer 24 is coated reflective material formed on the peripheral surface 22, but there is no reflective material on the side surface opposing the light source 70. The reflective layer 24 is made from aluminum, silver or other reflective material and is capable of reflecting the leaked light beams back to the light guide plate 20.

The reflective plate 30 is mounted on the bottom of the housing 10 and opposes the emitting surface 21 of the light guide plate 20. The reflective plate 30 reflects the leaked light beams back to the light guide plate 20, to prevent light leakage and increase the light use efficiency.

The diffuser plate 40 is mounted on the light guide plate 20 relative to the emitting surface 21 and is substantially parallel to the light guide plate 20. The diffuser plate 40 is made from polyethylene terephthalate (PET) or polycarbonate (PC), and may be formed by diffuser film(s) and provides a uniform surface light source for the LCD. The diffuser plate 40 includes a concave-convex diffusing surface 41 relative to the emitting surface 21. The diffusing surface 41 refracts, reflects, and scatters the light beams from the light guide plate 20.

The first prism plate 50 and the second prism plate 60 are mounted consecutively and substantially parallel on the diffuser plate 40 bottom to top. The first prism plate 50 and the second prism plate 60 are made from polyester or PC and are formed by brightness enhancement film (BEF). The first prism plate 50 and the second prism plate 60 refract and reflect the light beams from the diffuser plate 40 to increase the illumination and of the light beams.

The light source 70 is located between the housing 10 and one side of the light guide plate 20 corresponding to the reflective layer 24 to provide point light source or line light source for the light guide plate 20.

In use, the light source 70 emits and provides light beams for the light guide plate 20. Parts of the emitted light beams enter the light guide plate 20 and are scattered and reflected by the optical dots 23, to make the light beams uniformly emit and convert the point light source or the line light source into surface light source. Other parts of the emitted light beams are reflected by the reflective layer 24 of the light guide plate 20 and/or the reflective coating 14 of the housing 10 back to the light guide plate 20 and are scattered and reflected by the optical dots 23. The light beams from the light guide plate 20 are diffused by the diffuser plate 40 to provide a uniform light source. The first prism plate 50 and the second prism plate 60 refracts and reflects the light beams from the diffuser plate 40 to increase the illumination and of the light beams.

In summary, in the backlight module 100 of the exemplary embodiment, the reflective layer 24 and the reflective coating 14 can reflect the light beams back to the light guide plate 20 for reuse, which avoids light leakage. Thus, the backlight module 100 can increase illumination, save light source and provide a uniform light source for the LCD of the electronic device.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A backlight module, comprising:
a housing comprising a reflective coating located on an inner surface of the housing;
a light source received within the housing and for providing light beams;
a light guide plate received within the housing and for converting the light beams into corresponding surface light source;
a diffuser plate received within the housing and mounted on the light guide plate, the diffuser plate for unifying the light beams from the light guide plate; and
a prism plate received within the housing and mounted on the diffuser plate, the prism plate for increasing illumination of the light beams, wherein parts of the light beams are reflected by the reflective coating back to the light guide plate, and the reflected light beams pass through the diffuser plate and the prism plate.

2. The backlight module as claimed in claim 1, wherein the light guide plate comprises an emitting surface, and the emitting surface is formed with a plurality of optical dots, the optical dots scatter and reflect the light beams to convert the light beams into a uniform surface light source.

3. The backlight module as claimed in claim 2, wherein the optical dots are formed by cutting or etching.

4. The backlight module as claimed in claim 2, wherein the light guide plate further comprises a peripheral surface perpendicularly connected to the emitting surface, and one side of the peripheral surface faces toward the light source.

5. The backlight module as claimed in claim 4, wherein the light guide plate further comprises a reflective layer, the reflective layer is coated reflective material formed on the peripheral surface except the side surface opposing the light source.

6. The backlight module as claimed in claim 5, wherein the reflective material is any of silver or aluminum.

7. The backlight module as claimed in claim 1, wherein the material of the reflective coating is any of aluminum or silver.

8. The backlight module as claimed in claim 1, wherein the light guide plate is made from acrylic.

9. The backlight module as claimed in claim 1, wherein the backlight module further comprises a second prism plate parallel mounted on the diffuser plate, each prism plate is capable of refracting and reflecting the light beams from the diffuser plate to increase illumination and of the light beams.

10. A backlight module, comprising:
a housing comprising a reflective coating located on an inner surface of the housing;
a light source received within the housing and for providing corresponding light beams;
a light guide plate received within the housing and for converting the light beams into corresponding surface light source, and the light guide plate comprising a reflective layer;
a diffuser plate received within the housing and parallel mounted on the light guide plate, the diffuser plate for receiving the light beams form the light guide plate and unifying the light beams;
a first prism plate received within the housing and parallel mounted on the diffuser plate; and
a second prism plate received within the housing and parallel mounted on the first prism plate, the first and second prism plates for increasing illumination of the light beams, wherein parts of the light beams enter the light guide plate to form the surface light source, and other parts of the light beams are reflected by the reflective coating and the reflective layer back to the light guide plate to form surface light source, and the light beams from the light guide plate pass through the diffuser plate, the first prism plate and the second prism.

11. The backlight module as claimed in claim 10, wherein the light guide plate comprises an emitting surface, and the emitting surface comprises a plurality of optical dots, the optical dots scatter and reflect the light beams to convert the light beams into uniform surface light source.

12. The backlight module as claimed in claim 11, wherein the optical dots are formed by cutting or etching.

13. The backlight module as claimed in claim 11, wherein the light guide plate further comprises a peripheral surface perpendicularly connected to the emitting surface, and one side of the peripheral surface faces toward the light source.

14. The backlight module as claimed in claim 13, wherein the reflective layer is coated reflective material formed on the peripheral surface except the side surface opposing the light source.

15. The backlight module as claimed in claim 14, wherein the reflective material is any of silver or aluminum.

16. The backlight module as claimed in claim 10, wherein the material of the reflective coating is any of aluminum or silver.

17. The backlight module as claimed in claim 10, wherein the light guide plate is made from acrylic.
